(19) United States
(12) Patent Application Publication
(10) Pub. No.: US 2012/0296995 A1
(43) Pub. Date: Nov. 22, 2012

(54) Network-Application Association Method and System

(75) Inventor: Min Yan, Shenzhen City (CN)

(73) Assignee: TENCENT TECHNOLOGY (SHENZHEN) COMPANY LIMITED, Shenzhen City, Guangdong Province (CN)

(21) Appl. No.: 13/514,962

(22) PCT Filed: Dec. 20, 2010
(86) PCT No.: PCT/CN2010/080018

§ 371 Date: Jun. 8, 2012

(30) Foreign Application Priority Data
Jan. 14, 2010 (CN) 201010042792.0

(51) Int. Cl. G06F 15/16

(52) U.S. Cl. 709/206; 709/204

(57) ABSTRACT

A network-application association method comprises: performing corresponding operations for applications according to instructions of users; sending out association information according to users' relationship chains of the users and relations among the applications; judging whether the users respond to the association information; if the users respond to the association information, updating the users' relationship chains of the users or performing corresponding operations for the applications, according to operations for the users responding to the association information. In addition, the present invention further provides a network-application association system. In the above network-application association technology analyzes the users' relationship chains of the users and the relations among the applications, to find out the implicit relations among the users of the different applications, so as to use the association information to built the association among the different application and inform the users, such that the different applications are combined together, to enrich network service.

### FIELD OF THE INVENTION

The present invention relates to the field of the computer technology, and more particularly to a network-application association method and a network-application association system.

### BACKGROUND OF THE INVENTION

The development of the network technology of the computer creates a novel method for the communication among the people, and the people may exploit, maintain and enhance the society association network via SNS (Social Networking Services) applications. For example, some game applications, such as the Happy Farm, the Millionaire City of the Facebook, etc., not only achieve the recreation and entertainment, but also communicate with friends, workmates and schoolmates, etc.

Traditionally, each of the SNS applications is independent, and there is substantially no any relation between every two of the SNS applications. A same SNS application may generate the interaction via the users' relationship, however, different SNS applications cannot generate the interaction thereamong. For example, the users which are friends with each other, may perform operations, such as “manuring”, “watering” or “weeding”, etc., in the opposite side's farm, such that the different users may perform the interaction via the same SNS application. However, no any direct and generic structure connection and data communication are among the different SNS applications, such as “the Happy Farm” and “the Party Town”, etc.

In the current structures of the communities and the SNS applications, since no any generic data interface and interactive rendering exists among the different SNS applications, each of the SNS applications is independent, and is no any direct and generic structure connection and data communication. This state will cause that users' action data in each of the SNS applications are independent respectively, and cannot be shared with each other. Furthermore, user groups in each of the SNS applications cannot be multiplexed, superposed, and magnified. Users' experiences and rendering in each of the SNS applications cannot be multiplexed. The play of each of the SNS applications (specifically, for the game SNS applications) are independent, lacks the combination and variation. In the same overall situation, the lifecycle of a single SNS application is determined only by the quality of the single SNS application itself and the acceptance degree of the users, and other SNS applications cannot directly generate the influence.

### SUMMARY OF THE INVENTION

Therefore, for solving the problem of the applications independent respectively, a network-application association method and a network-application association system are provided.

To solve the above problem, the present invention is achieved as following:

A network-application association method comprises: performing corresponding operations for applications according to instructions of users; sending out association information according to users' relationship chains of the users and relations among the applications; judging whether the users respond to the association information; and if the users respond to the association information, updating the users' relationship chains of the users or performing corresponding operations for the applications, according to operations for the users responding to the association information.

The step of sending out association information according to users' relationship chains of the users and relations among the applications, comprises: if determining the users have a common friend according to the users' relationship chains of the users, and the applications are simultaneously used by the users, the association information is sent out to the users via the applications, and it is intermediate friend-recommending information configured for recommending opposite users as friends.

The step of sending out association information according to users' relationship chains of the users and relations among the applications, comprises: if determining the users are strangers with each other according to the users' relationship chains of the users, and the applications are simultaneously used by the users, the association information is sent out to the users via the applications, and it is same-application friend-recommending information configured for recommending opposite users as friends.

The method further comprises: analyzing users' actions of the users, and sending out the same-application friend-recommending information if determining the users' actions have similarity, before sending out the same-application friend-recommending information.

The step of sending out association information according to users' relationship chains of the users and relations among the applications, comprises: if determining the users are a same user according to the users' relationship chains of the users, and the relations among the applications indicate parameters of the applications belong to a same type or are able to be converted with each other, the association information is sent out to the users via the applications, and it is crossing-application information configured for moving or converting the parameters.

A network-application association system, comprises:

an application module, comprising a plurality of applications and configured for receiving instructions of users to perform corresponding operations for the applications; and further configured for judging whether the users responding to association information and informing an association module when the users respond to the association information;

a storing module, configured for storing parameters and users' relationship chains of the users of the applications;

an association module, electrically coupled to the application module and the storing module respectively, and configured for sending out association information according to the users' relationship chains of the users and relations among the applications, and updating the users' relationship chains or perform corresponding operations for the applications according to operations for the users responding to the association information after receiving information of the application module.

The association module comprises an application interactive interface, a task-event unit, a relationship chain engine, a users' rendering unit and a communication and message unit;

the communication and message unit is configured for building communication among the application interactive interface, the task-event unit, the relationship chain engine and the users' rendering unit;

the application interactive interface is configured for being communicated with the application module and informing operations of the users operating in the applications to the task-event unit;

the task-event unit is configured for sending out a relationship-chain querying request to the relationship chain engine when receiving the informing, and informing the applications via the application interactive interface if a querying result returned from the relationship chain engine indicates the users have a common friend and the users are simultaneously using the applications;

the users' rendering unit is configured for sending out association information to the users, and the association information is intermediate friend-recommending information configured for recommending opposite users as friends;

the relationship chain engine is configured for querying the users' relationship chains stored in the storing module and returning the querying result to the task-event unit; and further configured for updating the users' relationship chains of the storing module when the users respond to the association information.

The association module comprises an application interactive interface, a task-event unit, a relationship chain engine, a users' rendering unit, and a communication and message unit;

the communication and message unit is configured for building communication among the application interactive interface, the task-event unit, the relationship chain engine and the users' rendering unit;

the application interactive interface is configured for being communicated with the application module and informing operations of the users operating in the applications to the task-event unit;

the task-event unit is configured for sending out a relationship-chain querying request to the relationship chain engine when receiving the informing, and informing the applications via the application interactive interface if a querying result returned from the relationship chain engine indicates the users are strangers, and the applications are a same application and simultaneously used by the users;

the users' rendering unit is configured for sending out association information to the users, and the association information is same-application friend-recommending information configured for recommending opposite users as friends;

the relationship chain engine is configured for querying the users' relationship chains stored in the storing module and returning the querying result to the task-event unit; and further configured for updating the users' relationship chains of the storing module when the users respond to the association information.

The association module comprises an application interactive interface, a task-event unit, a relationship chain engine, a users' rendering unit, a value-controlling unit, and a communication and message unit;

the communication and message unit is configured for building communication among the application interactive interface, the task-event unit, the relationship chain engine and the users' rendering unit;

the application interactive interface is configured for being communicated with the application module and informing operations of the users operating in the applications to the value-controlling unit;

the value-controlling unit is configured for modifying value options of the users in the applications according to the operations, and informing the task-event unit when values of the value options satisfy predetermined requests;

the task-event unit is configured for sending out a relationship-chain querying request to the relationship chain engine when receiving the informing, and informing the applications via the application interactive interface if a querying result returned from the relationship chain engine indicates the users are strangers, and the applications are a same application and simultaneously used by the users;

the users' rendering unit is configured for sending out association information to the users, and the association information is same-application friend-recommending information configured for recommending opposite users as friends;

the relationship chain engine is configured for querying the users' relationship chains stored in the storing module and returning the querying result to the task-event unit; and further configured for updating the users' relationship chains of the storing module when the users respond to the association information.

The association module comprises an application interactive interface, a task-event unit, a users' rendering unit, a parameter unit and a communication and message unit;

the communication and message unit is configured for building communication among the application interactive interface, the task-event unit, the users' rendering unit and the parameter unit;

the application interactive interface is configured for being communicated with the application module and informing operations of the users operating in the applications to the task-event unit;

the task-event unit is configured for sending out a parameter-conversion querying request to the parameter unit when receiving the informing, and informing the applications via the application interactive interface if a querying result returned from the parameter unit satisfies a condition of the parameters belonging to a same type or capable of be converted with each other;

the users' rendering unit is configured for sending out association information to the users, and the association information is crossing-application information configured for moving or converting the parameters;

the parameter unit is configured for querying results for converting the parameters among the different applications and returning a querying result to the task-event unit; and further configured for updating the parameters of the applications stored in the storing module when the users respond to the association information.

The above network-application association method and system, analyze the users' relationship chains of the users and the relations among the applications, to find out the implicit relations among the users of the different applications, so as to use the association information to built the association among the different applications and inform the users, such that the association is built among the different applications and the different applications are combined together, to solve the problem of the plurality of the applications independent respectively, share the related data of each of the application, enrich the network service, superpose and magnify the users' groups, multiplex the users' experience, for forming the scale effect and the reinforcing effect, improve the users' activity of the applications, and have the strong long core competitiveness.

The present invention can enrich the use of the different applications, also can help the service operators to concert and manage the lifecycle and the operation events of the applications. Furthermore, the present invention can adequately use the users' relationship chains, to provide the interacting channels among the applications, which comprise the synchronization of the users' actions, the trigger of the users' actions, etc.

### BRIEF DESCRIPTION OF THE DRAWINGS

The present invention will become more readily apparent to those ordinarily skilled in the art after reviewing the following detailed description and accompanying drawings, in which:

FIG. 1 is a flow chart of a network-application association method.

FIG. 2 is a schematic module view of a network-application association system.

FIG. 3 is a schematic structure view of an association module.

FIG. 4 is a schematic view for showing an operation flow of the network-application association system in accordance with a first exemplary embodiment.

FIG. 5 is a schematic view for showing an operation flow of the network-application association system in accordance with a second exemplary embodiment.

FIG. 6 is a schematic view for showing an operation flow of the network-application association system in accordance with a third exemplary embodiment.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

For solving the problem of each of SNS applications being independent, the present invention employs pre-existing users' relationship chains, to analyze relations among different SNS applications, for employing the relations which may be latent and still not used, to achieve the interaction among the different applications.

The substantial principle of the present invention is: building a application structure based on public interface of applications, to employ a standard interface set in the application structure, for achieving the specific user information and user data transmission among the different applications, and employ a backstage logic configuration of the application structure, for absorbing and merging application modes or logic rules of the applications, and then showing user interfaces by words or patterns in the application respectively.

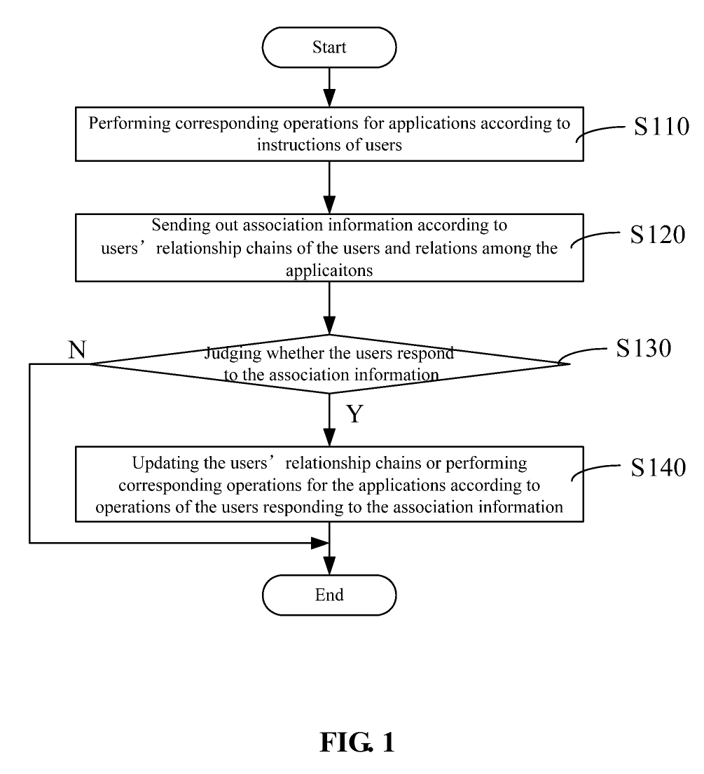

As shown in FIG. 1, a network-application interacting method comprises as following:

S110: performing corresponding operations for applications according to instructions of users.

The instructions of the users may be logging-in, moving or clicking in each of regions by a mouse, etc. The applications may be various applications of the network service, and comprise web applications and client applications. For example, the applications may be SNS applications (e.g., games, such as, the Happy Farm, the Party Town, The Kingdoms of Camelot, etc., or photo albums or blogs, etc.). Alternatively, the applications also may be non-SNS applications with identity information, such as real-time game (e.g., card games or chess games) platforms or friend-making platforms, etc., which should be logged in by users' information. For example, for the Happy Farm game, if an user inputs his user's name and password, and sends out a logging-in instruction, to request to log in the Happy Farm, the performed corresponding operation is reading correlative game parameters of the user, and transmitting a game interface to a client where the user is located.

S120: sending out association information according to users' relationship chains of the users and relations among the applications.

In detail, when a plurality of users use the applications simultaneously, the applications used by the different user may be same or different. The users' relationship chains of the users are achieved respectively. If the users' relationship chains of the users indicate the users have common friends and the applications are used by the users simultaneously, the association information sent out to the users via the applications, may be intermediate friend-recommending information which is configured for recommending opposite user as friends, or recommending information of other applications.

Alternatively, when a plurality of users use a same application, users' actions of the users are analyzed to determine the users' actions have the similarity. The users' relationship chains of the users are achieved respectively. If the users' relationship chains of the users indicate the users are strangers with each other, the association information sent out to the users via the application, may be same-application friend-recommending information, which is configured for recommending opposite users as friends to the users.

Alternatively, when a same user uses different applications, the users' relationship chains of the users and related parameters of the applications are achieved. If the users' relationship chains of the users indicates the users using the different application are a same user, and the relations among the applications belong to a same type or are able to be converted with each other. If the related parameters of the applications satisfy the predetermined need, the association information sent out to the users via the applications may be crossing-application information for moving or converting the parameters.

In the simple applications, the relation among the users may be simplified to be the friend relation and the stranger relation. Not only friends but also strangers, may use the friend relations of the users with each other to form the friend relationship chain. In the complicated applications, the friends of the users may be further grouped to distinguish different friends. The above users' relationship chains may comprise the friend relation, the stranger relation, the stranger relation via the friend connection, the own condition of the users. The relations among the applications may be that the applications are a completely same application or applications with a same type (e.g., they are all relaxing games or real-time games). Of course, the relations among the applications may be discriminated by parameter types of the applications, for example, all of the parameter types thereof relate to experience values, economic values, action types, etc. Alternatively, the relations among the applications may be discriminated by time, for example, two users simultaneously use two applications respectively. The association information is sent out according to the users' relationship chains and the relations among the applications, to achieve the association among the different applications. For example, the obtained users' relationship chains of the users indicate the two users A and B are strangers with each other, but both of the users A and B have a common friend, such as a user C. The user A is playing the Happy Farm game, and the user B is playing the Happy Manor game. Therefore, the association information, which may be “the user B which is the friend of the user C, is playing the Happy Manor game, and whether is willing to add the user B as a friend or add to playing the Happy Manor game”, is sent out on the interface of the Happy Farm game, to achieve the association among the different applications. For another example, the obtained users' relationship chains of the users indicate the two users A and B are strangers with each other, but the two users A and B are simultaneously using a same application, such as the Happy Farm game. The parameters (such as, experience values, economic values, action types, etc.) of the users A and B are analyzed to be similar, thus the association information, which may be “the user B is similar to you in the game, and whether is willing to add the user B as a friend”, is sent out on the interface of the Happy Farm game, to achieve the association among the different users. For other example, the obtained users' relationship chains of the users indicate a same user, such as the user A, has used the Happy Farm game and the Happy Manor game, and the obtained parameters of the applications indicate that the economic values of the two applications belong to a same type or are parameters which are converted with each other. After using the two applications to a predetermined degree, that is, the parameters reaching a predetermined request, such as reaching a predetermined economic value, the association information, which may be “whether exchange a happy treasure in the Happy Manor game”, is sent out on the interface of the Happy Farm game, to achieve the association among the different applications.

S130: judging whether the users respond to the association information. The users may not respond to the association information. When the users respond to the association information, such as clicking button of “adding” or “buying”, etc., to perform a following operation, a following step S140 enters. Otherwise, the flow is over.

S140: updating the users' relationship chains or performing corresponding following operations for the applications according to the operation for the user responding to the association information, if the user responds to the association information. For example, if the user clicks the button of “adding”, another user is added as a friend of the user, and the users' relationship chain should be updated. For another example, if the user clicks the button of “buying”, goods which should be bought, is added to the goods list of the user, and the related parameters of the application are updated.

The above network-application interacting method analyzes the users' relationship chains of the users and the relations among the applications, to use the association information to built the association among the different applications and inform the user, such that the different applications may be combined together.

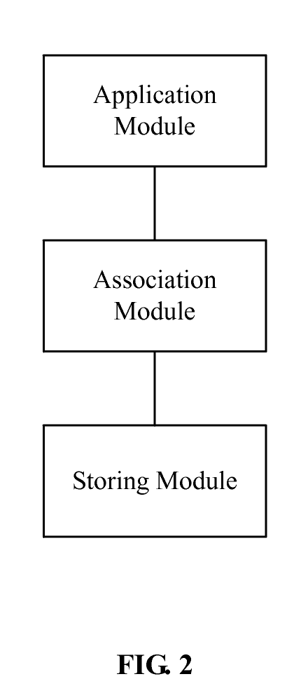

As shown in FIG. 2, a network-application interacting system is provided. The system comprises an application module, a storing module and an association module.

The application module comprises a plurality of applications, and is configured for receiving instructions of users to perform corresponding operations for the applications. The instructions of the users may be logging-in, moving or clicking in each of regions by a mouse, etc. The applications may be various applications of the network service, and comprise web applications and client applications. For example, the applications may be SNS applications (e.g., games, such as the Happy Farm, the Party Town, or the Kingdoms of Camelot, etc., or photo albums or blogs, etc.). Alternatively, the applications also may be non-SNS applications with identity information, such as real-time game (e.g., card games or chess games) platforms or friend-making platforms, etc., which should be logged in by users' information. For example, for the Happy Farm game, if the user inputs his name and password, and sends out a logging-in instruction to request to log in the Happy Farm game, the corresponding operation performed by the application module, is reading correlative game parameters of the user and transmitting a game interface to a client where the user is located.

The storing module is configured for storing users'information and users' relationship chains. The users' information comprises users' name, registering time, open application's name, and parameters of the different applications, etc. In the simple applications, the relations among the users may be simplified to be the friend relation and the stranger relation. In the large amount of the users, friend relationship chains may be generated according to the friend relations among the users. In the complicated applications, the friends of the users may be further grouped to distinguish different friends.

The association module is connected with the application module and the storing module respectively, and is configured for sending out association information according to users' relationship chains of the users and relations among the applications. The application module is further configured for judging whether the user responds to the association information, and informing the association module when the user responds to the association information. The association module is further configured for updating the users' relationship chains or performing a corresponding operation for the applications according to the operation of the user responding to the association information, after receiving the information of the application module. The users' relationship chains may comprise the friend relation, the stranger relation, the stranger relation via the friend connection, the own condition of the user. The relations among the applications may be that the applications are a completely same application or applications with a same type (e.g., they are all relaxing games or real-time games). Of course, the relations among the applications may be discriminated by parameter types of the applications, for example, all of the parameter types thereof relate to experience values, economic values, action types, etc. Alternatively, the relations among the applications may be discriminated by time, for example, two users simultaneously use two applications respectively, thus the two applications are the applications in use simultaneously. The association information is sent out according to the users' relationship chains and the relations among the applications, to achieve the association among the different applications. For example, the users' relationship chains of the uses obtained by the association module, indicate that the two users A and B are strangers with each other, but both of the users A and B have a common friend, such as a user C. The user A is playing the Happy Farm game, and the user B is playing the Happy Manor game. Therefore, the association information, which may be “the user B which is the friend of the user C, is playing the Happy Manor game, and whether is willing to add the user B as a friend or add to playing the Happy Manor game”, is sent out on the interface of the Happy Farm game, to achieve the association among the different applications. For another example, the users' relationship chains of the users obtained by the association module indicate the two users A and B are strangers with each other, but the two users A and B are simultaneously using a same application, such as the Happy Farm game. The parameters (such as, experience values, economic values, action types, etc.) of the users A and B are analyzed to be similar, thus the association information, which may be “the user B is similar to you in the game, and whether is willing to add the user B as a friend”, is sent out on the interface of the Happy Farm game, to achieve the association among the different users. For other example, the users' relationship chains of the users obtained by the association module indicate a same user, such as the user A, has used the Happy Farm game and the Happy Manor game, and the parameters of the applications obtained by the association module indicate that the economic values of the two applications belong to a same type or are parameters which are converted with each other. After using the two applications to a predetermined degree, that is, the parameters reaching a predetermined request, such as reaching a predetermined economic value, the association information, which may be “whether exchange a happy treasure in the Happy Manor game”, is sent out on the interface of the Happy Farm game, to achieve the association among the different applications. The user may not respond to the association information. When the user responds to the association information, such as clicking button of “adding” or “buying”, etc., if the user clicks the button of “adding”, another user is added as a friend of the user. The application module informs the association module when determining the user responding to the association information, and the association module updates the users' relationship chains stored in the storing module. If the user clicks the button of “buying”, goods which should be bought, is added to the goods list of the user. The application module informs the association module when determining the user responding to the association information, and the association module updates the parameters of the applications stored in the storing module.

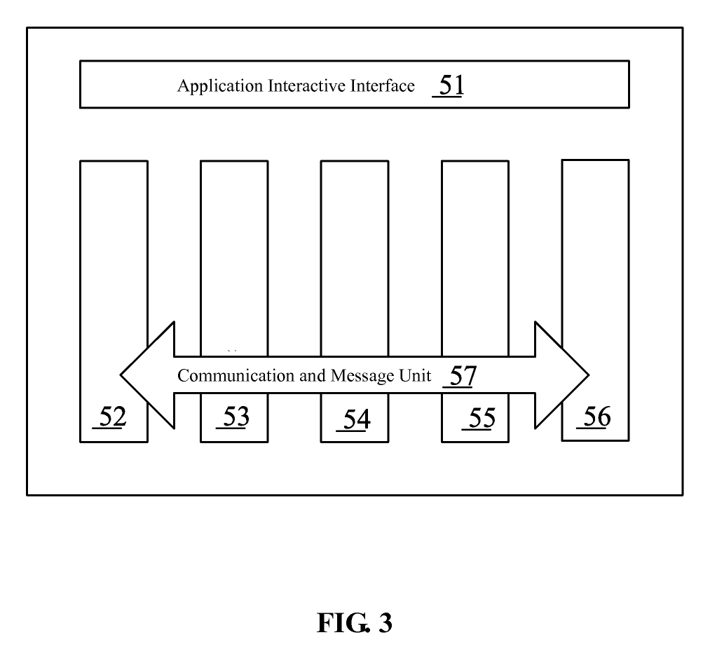

For further explaining the above method and system, the following will employ detailed exemplary embodiments to describe the present invention. As shown in FIG. 3, the association module comprises an application interactive interface 51, a users' rendering unit 52, a value-controlling unit 53, a task-event unit 54, a parameter unit 55, a relationship-chain engine 56 and a communication and message unit 57. The communication and message unit 57 is configured for building the communication among the application interactive interface 51, the users' rendering unit 52, the value-controlling unit 53, the task-event unit 54, the parameter unit 55 and the relationship-chain engine 56, and charging the information communication and share among the above units.

The application interactive interface 51 is configured for performing the information communication between the system and each of the applications. The information communication may be bidirectional. The applications can synchronize the operations of the users in the applications for the system via the application interactive interface 51. Meanwhile, the system can synchronize the operations of the users in other applications for the application or trigger new operations of the users in the application via the application interactive interface 51.

The users' rendering unit 52 is configured for rendering the association information for the users via the application, and also configured for rendering various information of the system.

The value-controlling unit 53 is configured for collecting the parameters of the applications used by the users, and performing the calculating operation according to predetermined rules to be used by other modules or applications.

The task-event unit 54 is configured for charging the collecting/managing operation of various tasks or events, and comprises various tasks or events triggered by predetermined rules. The tasks or events may cross over each of the applications, to effectively connect the applications.

The parameter unit 55 is configured for querying the converting result of the parameters of the different applications, and managing the parameters of the applications.

The relationship-chain engine 56 is configured for querying and managing the users' relationship chains of the users.

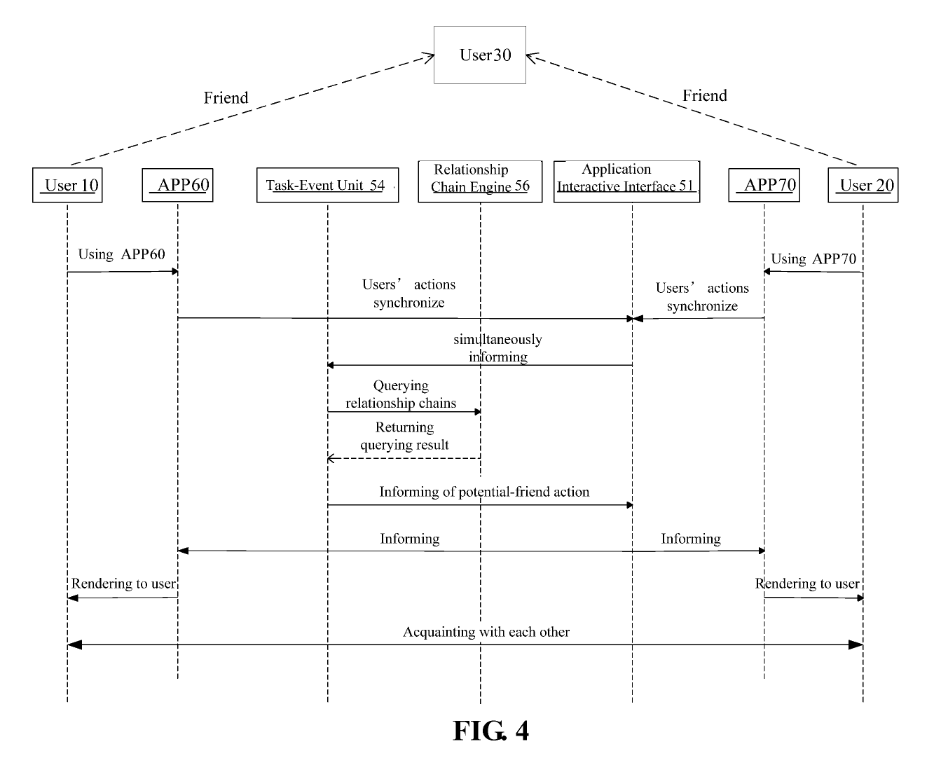

Referring to FIG. 4 together, which is a schematic view for showing the operation flow of the network-application association system in accordance with a first exemplary embodiment. A user 10 and a user 20 both have a common friend, such as a user 30. An APP 60 and an APP 70 are two different applications. Firstly, the user 10 and the user 20 use the APP 60 and the APP 70 respectively. The actions of the user 10 and the user 20 are simultaneously transmitted to the application interactive interface 51. The application interactive interface 51 performs the information communication with the APP 60 and the APP 70 in the application module, to synchronize the users' actions. The application interactive interface 51 informs the operation of the user 10 and the user 20 operating in the application module, to the task-event unit 54. The task-event unit 54 sends out a relationship-chain querying request to the relationship-chain engine 56 after receiving the information. The relationship-chain engine 56 queries the users' relationship chain stored in the storing module and returns a querying result to the task-event unit 54. The task-event unit 54 is configured for determining that the user 10 and the user 20 both have the common friend, that is, the user 30 according to the querying result, and the user 10 and the user 20 simultaneously use the APP 60 and the APP 70, to inform the APP 60 and the APP 70 via the application interactive interface 51. Such that the users' rendering unit 52 sends out intermediate friend-recommending information as the association information, which recommends the opposite as a friend, to the APP 60 and the APP 70. The APP 60 is rendered to the user 10, and the APP 70 is rendered to the user 20. If the user 10 and the user 20 respond to the association information, the user 10 and the user 20 are made as the friends. In summary, if the users' relationship chains of the users indicate the users have the common friend, and the relations of the applications are simultaneously used by the users, the intermediate friend-recommending information, which recommends the opposite as a friend thereof, is sent out via the applications.

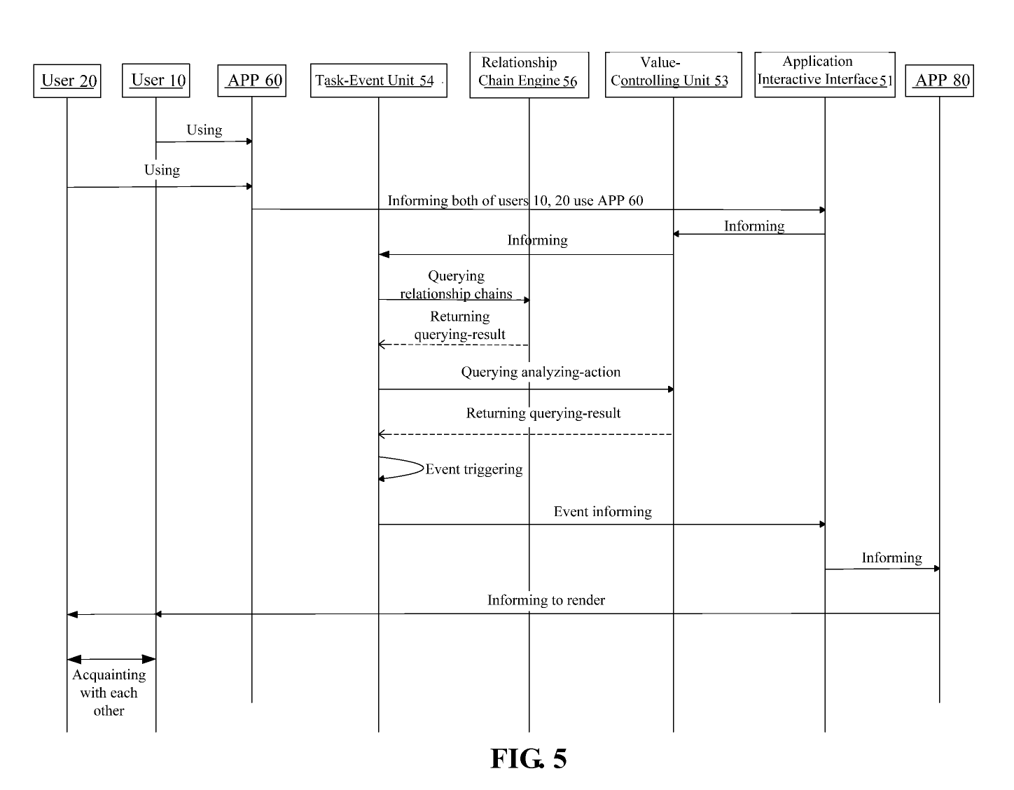

Referring to FIG. 5 together, which is a schematic view for showing the operation flow of the network-application association system in accordance with a second exemplary embodiment. The user 10 and the user 20 both use the APP 60. The actions of the user 10 and the user 20 are simultaneously transmitted to the application interactive interface 51. The application interactive interface 51 performs the information communication with the application module, receives the information of the application module, and informs the operation of the user 10 and the user 20 operating in the application module to the value-controlling unit 53. The value-controlling unit 53 varies the parameters of the user 10 and the user 20 in the APP 60 according to the operation, and informs to the task-event unit 54 when the parameters satisfies a predetermined request. The task-event unit 54 sends out a relationship-chain querying request to the relationship-chain engine 56 after receiving the information. The relationship-chain engine 56 queries the users' relationship chain stored in the storing module and returns a querying result to the task-event unit 54. The task-event unit 54 determines the user 10 and the user 20 are strangers with each other, and the applications are a same application and simultaneously used by the users so as to satisfy the predetermined trigger event according to the querying result, the task-event unit 54 informs the APP 80 via the application interactive interface 51, and the users' rendering unit 52 sends out same-application friend-recommending information as the association information, which recommends the opposite as a friend, to the user 10 and the user 20. Then the same-application friend-recommending information is rendered to the users 10 and 20 by the APP 80. According to the same-application friend-recommending information, the user 10 and the user 20 may respond to the association information, and be acquainted with each other to be made as friends. In the above exemplary embodiment, the APP 80 is used to render the same-application friend-recommending information to the users, and need not to alter the APP 60, such as to update the original application. In other exemplary embodiments, the APP 60 may be informed via the application interactive interface 51, so as to use the APP 60 to rendering the same-application friend-recommending information to the users. In summary, the above exemplary embodiment analyzes the actions of the users. If a result for analyzing the actions of the users indicates the actions of the users have the similarity, the users' relationship chain indicates the users are strangers with each other, and the applications used by the users are a same application and simultaneously used by the users, the same-application friend-recommending information, which recommends the opposite as the friend, to the users, is sent out to the users via the applications.

In addition, the present invention also may not set the prerequisite of the parameters satisfying the predetermined request. In detail, the application interactive interface 51 performs the information communication with the application module, synchronizes the actions of the users, and informs the operation of the users operating in the application module to the task-event unit 54. The task-event unit 54 sends out a relationship-chain querying request to the relationship-chain engine 56 after receiving the information. The relationship-chain engine 56 queries the users' relationship chain stored in the storing module and returns a querying result to the task-event unit 54. The task-event unit 54 determines the users are strangers with each other, the applications are a same application and simultaneously used by the users according to the querying result, the applications are informed via the application interactive interface, and the users' rendering unit 52 sends out same-application friend-recommending information as the association information, which recommends the opposite as the friend, to the users. In summary, if the users' relationship chain of the user indicates the users are strangers with each other, and the applications are a same application and simultaneously used by the users, the association information may be the same-application friend-recommending information, which recommends the opposite as the friend and sent out to the users via the applications.

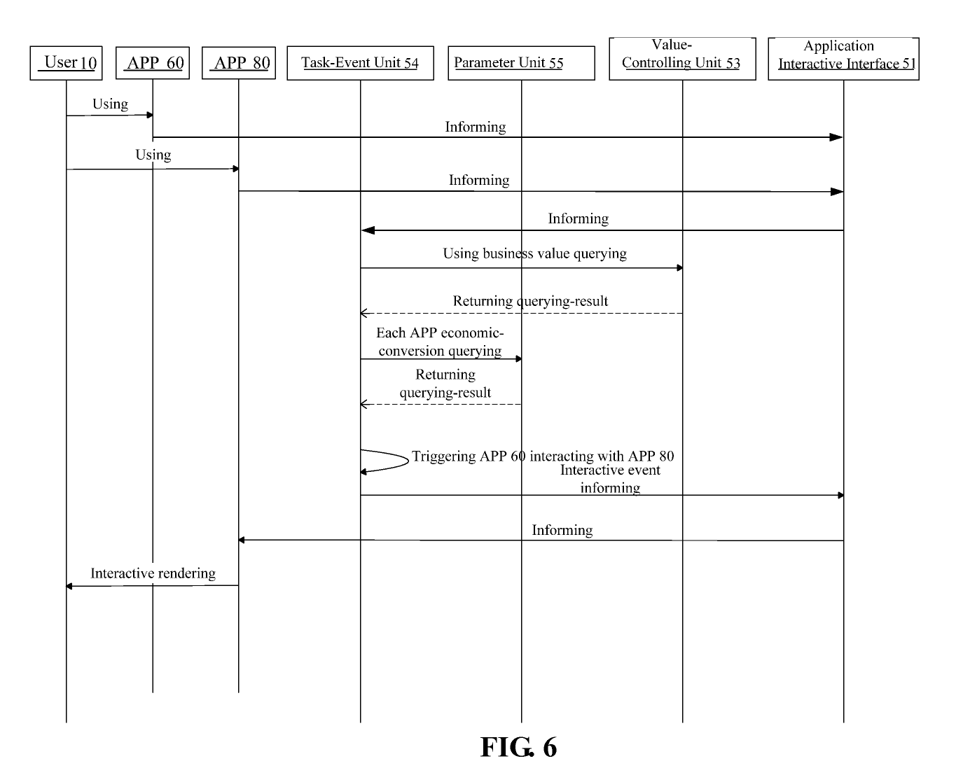

Referring to FIG. 6 together, which is a schematic view for showing an operation flow of a network-application association system in accordance with a third exemplary embodiment. The user 10 uses the APP 60 and the APP 80. The application interactive interface 51 performs the information communication with the application module, receives the information of the application module, and informs the operation of the user 10 operating in the application module to the task-event unit 54. The task-event unit 54 is configured for determining the APP 60 and the APP80 are used by the same user, and sending out a parameter-conversion querying request to the parameter unit 55 after receiving the information. The parameter unit 55 queries results for converting parameters among the different applications, and returns a querying result to the task-event unit 54. The task-event unit 54 informs the APP 80 via the application interactive interface 51 if the querying result satisfies a condition of types of parameters being same or capable of being converted from each other, such that the users' rendering unit 52 sends out crossing-application information for the parameters moving or converting, which is as association information, to the user 10. For example, if the economic value of the user in the Happy Farm game is enough to exchange a happy treasure in the Happy Manor game, the economic value in the Happy Farm game may be moved or converted in the Happy Manor game. Similarly, other parameters, such as the experience value or the on-line time, also may be moved or converted. In summary, if the users' relationship chain of the user indicates the users is a same user, and the relation among the different applications indicates the parameters belong to a same type or are able to be converted with each other, the association information is crossing-application information for moving or converting the parameters to the user via the applications. In addition, before the task-event unit 54 sends out the parameter-conversion querying request to the parameter unit 55, it may further comprise querying the value-controlling unit 53. It permits performing the parameter-conversion querying operation, and moving or converting the parameter, only if the parameter achieves the predetermined request.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A network-application association method, comprising:
performing corresponding operations for applications according to instructions of users;
sending out association information according to users' relationship chains of the users and relations among the applications;
judging whether the users respond to the association information; and
if the users respond to the association information, updating the users' relationship chains of the users or performing corresponding operations for the applications, according to operations for the users responding to the association information.

2. The network-application association method as claimed in claim 1, wherein the step of sending out association information according to users' relationship chains of the users and relations among the applications, comprises: if determining the users have a common friend according to the users' relationship chains of the users, and the applications are simultaneously used by the users, the association information is sent out to the users via the applications, and it is intermediate friend-recommending information configured for recommending opposite users as friends.

3. The network-application association method as claimed in claim 1, wherein the step of sending out association information according to users' relationship chains of the users and relations among the applications, comprises: if determining the users are strangers with each other according to the users' relationship chains of the users, and the applications are simultaneously used by the users, the association information is sent out to the users via the applications, and it is same-application friend-recommending information configured for recommending opposite users as friends.

4. The network-application association method as claimed in claim 3, further comprising: analyzing users' actions of the users and sending out the same-application friend-recommending information if determining the users' actions have similarity, before sending out the same-application friend-recommending information.

5. The network-application association method as claimed in claim 1, wherein the step of sending out association information according to users' relationship chains of the users and relations among the applications, comprises: if determining the users are a same user according to the users' relationship chains of the users, and the relations among the applications indicate parameters of the applications belong to a same type or are able to be converted with each other, the association information is sent out to the users via the applications, and it is crossing-application information configured for moving or converting the parameters.

6. A network-application association system, comprising:
an application module, comprising a plurality of applications and configured for receiving instructions of users to perform corresponding operations for the applications; and further configured for judging whether the users responding to association information and informing an association module when the users respond to the association information;
a storing module, configured for storing parameters and users' relationship chains of the users of the applications; and
an association module, electrically coupled to the application module and the storing module respectively, and configured for sending out association information according to the users' relationship chains of the users and relations among the applications, and updating the users' relationship chains or perform corresponding operations for the applications according to operations for the users responding to the association information after receiving information of the application module.

7. The network-application association system as claimed in claim 6, wherein the association module comprises an application interactive interface, a task-event unit, a relationship chain engine, a users' rendering unit and a communication and message unit;
the communication and message unit is configured for building communication among the application interactive interface, the task-event unit, the relationship chain engine and the users' rendering unit;
the application interactive interface is configured for being communicated with the application module and informing operations of the users operating in the applications to the task-event unit;
the task-event unit is configured for sending out a relationship-chain querying request to the relationship chain engine when receiving the informing, and informing the applications via the application interactive interface if a querying result returned from the relationship chain engine indicates the users have a common friend and the users are simultaneously using the applications;
the users' rendering unit is configured for sending out association information to the users, and the association information is intermediate friend-recommending information configured for recommending opposite users as friends; and
the relationship chain engine is configured for querying the users' relationship chains stored in the storing module and returning the querying result to the task-event unit; and further configured for updating the users' relationship chains of the storing module when the users respond to the association information.

8. The network-application association system as claimed in claim 6, wherein the association module comprises an application interactive interface, a task-event unit, a relationship chain engine, a users' rendering unit, and a communication and message unit;
the communication and message unit is configured for building communication among the application interactive interface, the task-event unit, the relationship chain engine and the users' rendering unit;
the application interactive interface is configured for being communicated with the application module and informing operations of the users operating in the applications to the task-event unit;
the task-event unit is configured for sending out a relationship-chain querying request to the relationship chain engine when receiving the informing, and informing the applications via the application interactive interface if a querying result returned from the relationship chain engine indicates the users are strangers, and the applications are a same application and simultaneously used by the users;
the users' rendering unit is configured for sending out association information to the users, and the association information is same-application friend-recommending information configured for recommending opposite users as friends; and
the relationship chain engine is configured for querying the users' relationship chains stored in the storing module and returning the querying result to the task-event unit; and further configured for updating the users' relationship chains of the storing module when the users respond to the association information.

9. The network-application association system as claimed in claim 6, wherein the association module comprises an application interactive interface, a task-event unit, a relationship chain engine, a users' rendering unit, a value-controlling unit, and a communication and message unit;
the communication and message unit is configured for building communication among the application interactive interface, the task-event unit, the relationship chain engine and the users' rendering unit;
the application interactive interface is configured for being communicated with the application module and informing operations of the users operating in the applications to the value-controlling unit;
the value-controlling unit is configured for modifying value options of the users in the applications according to the operations, and informing the task-event unit when values of the value options satisfy predetermined requests;
the task-event unit is configured for sending out a relationship-chain querying request to the relationship chain engine when receiving the informing, and informing the applications via the application interactive interface if a querying result returned from the relationship chain engine indicates the users are strangers, and the applications are a same application and simultaneously used by the users;
the users' rendering unit is configured for sending out association information to the users, and the association information is same-application friend-recommending information configured for recommending opposite users as friends; and
the relationship chain engine is configured for querying the users' relationship chains stored in the storing module and returning the querying result to the task-event unit; and further configured for updating the users' relationship chains of the storing module when the users respond to the association information.

10. The network-application association system as claimed in claim 6, wherein the association module comprises an application interactive interface, a task-event unit, a users' rendering unit, a parameter unit and a communication and message unit;
the communication and message unit is configured for building communication among the application interactive interface, the task-event unit, the users' rendering unit and the parameter unit;
the application interactive interface is configured for being communicated with the application module and informing operations of the users operating in the applications to the task-event unit;
the task-event unit is configured for sending out a parameter-conversion querying request to the parameter unit when receiving the informing, and informing the applications via the application interactive interface if a querying result returned from the parameter unit satisfies a condition of the parameters belonging to a same type or capable of be converted with each other;
the users' rendering unit is configured for sending out association information to the users, and the association information is crossing-application information configured for moving or converting the parameters; and
the parameter unit is configured for querying results for converting the parameters among the different applications and returning a querying result to the task-event unit; and further configured for updating the parameters of the applications stored in the storing module when the users respond to the association information.
